(19) United States
(12) Patent Application Publication
(10) Pub. No.: US 2002/0162623 A1
(43) Pub. Date: Nov. 7, 2002

(54) Coating method and a corresponding part

(76) Inventor: Serge Saint-Dizier, Valentigney (FR)

Correspondence Address: YOUNG & THOMPSON, 745 SOUTH 23RD STREET 2ND FLOOR, ARLINGTON, VA, 22202

(21) Appl. No.: 10/049,851

(22) PCT Filed: Jun. 20, 2001
(86) PCT No.: PCT/FR01/01937

(30) Foreign Application Priority Data
Jun. 21, 2000 (FR) 00 07949

(51) Int. Cl. B29C 47/00

(52) U.S. Cl. 156/245; 156/267; 156/250

(57) ABSTRACT

The invention concerns a method for making a coated part comprising an injected plastic material structure (4) coated with a main coat (6) and a secondary coat (14) enclosed by the surface of the first coating, comprising the following steps: bonding a secondary blank (30) on the apparent surface of a main blank (22); placing the main blank/secondary blank assembly in a mould (52) of a clamping frame (64) which maintains a clamping edge (24) of the main blank (22); simultaneously shaping the two blanks when the mould is closed; overmoulding the main blank/secondary blank assembly on the side of the main blank opposite the secondary blank with plastic material. The invention is applicable to inside panels of motor vehicle doors.

The present invention relates to a method of manufacturing a coated part, in particular for a motor vehicle, the part being of the type comprising a structure for injected plastics material coated in at least a first zone of its surface by a main coating and in at least a second zone of its surface by a secondary coating, said second surface zone being surrounded on at least a fraction of its periphery by said first zone.

The invention applies in particular to inside panels for motor vehicles.

In the state of the art, inside panels for motor vehicle doors are known in which the panels are made out of plastics material. A large fraction of the surface of the panel that is visible in the assembled state is coated in a main coating, e.g. a sheet of plastics material. Such sheets are generally inexpensive, but they present drawbacks from the points of view of appearance and comfort. For example they are disagreeable to touch. That is why such sheets are not used for the armrest zone of an inside panel. Consequently, a second coating is provided in the armrest zone, which coating is made of some other material, e.g. of fabric. These materials are generally more expensive than sheets of plastics material.

In the state of the art, inside panels are made as follows.

The second coating zone is made separately, either by overmolding or by overlaying the second coating on a part of injected structure, and it is then assembled onto the inside panel. Under such circumstances, the second coating is held by a clamping frame during overmolding or overlaying, so as to ensure that creases do not form.

When using a second coating made of a thermoformable material, the second coating is preferably initially thermoformed, cut out, and coated in adhesive. Thereafter it is overmolded simultaneously with the main coating of the door inside panel. In that case also, the second coating must be clamped in a clamping frame during the operation of thermoforming.

Both of the above-mentioned solutions require a coating blank to have a clamping margin in order to enable the blank to be held in the clamping frame. Consequently, those solutions use additional coating area, leading to a manufacturing cost that is high.

An object of the invention is to mitigate those drawbacks and to propose a coated inside panel for a door, the panel having a zone provided with a second coating which is of reduced manufacturing cost.

To this end, the invention provides a method of the above-specified type, characterized in that it comprises the following steps:

cutting out a main blank for the main coating to a size greater than the area of said first zone, thereby providing a clamping margin;

cutting out a secondary blank for the secondary coating to a size and a shape corresponding substantially to said second zone;

securing the secondary blank to the main blank on an area of said main blank that is to remain visible, in a location that corresponds to said second zone;

placing the assembly comprising the main blank and the secondary blank on a clamping frame in a mold, which frame positions the clamping margin of the main blank;

closing the mold, with the assembly comprising the main blank and the secondary blank being shaped during closure to take up the shape of the mold, at least in part;

overmolding the plastics material onto the assembly comprising the main blank and the secondary blank on the side of the main blank opposite from the secondary blank;

allowing the plastics material to set, and unmolding the structure as a whole; and

cutting off the clamping margin of the main blank.

In particular embodiments, the method of the invention can include one or more of the characteristics specified in dependent claims 2 to 13.

The invention also provides a coated part manufactured using one of the above-specified methods, characterized in that the part includes a groove formed in the coated surface, and in that the outline of the groove corresponds substantially to the outline of said secondary coating and receives the edge of said secondary coating, so as to hide it.

The coated part of the invention can have one or more of the characteristics specified in claims 15 to 19.

The invention will be better understood on reading the following description given purely by way of example and made with reference to the accompanying drawings, in which:

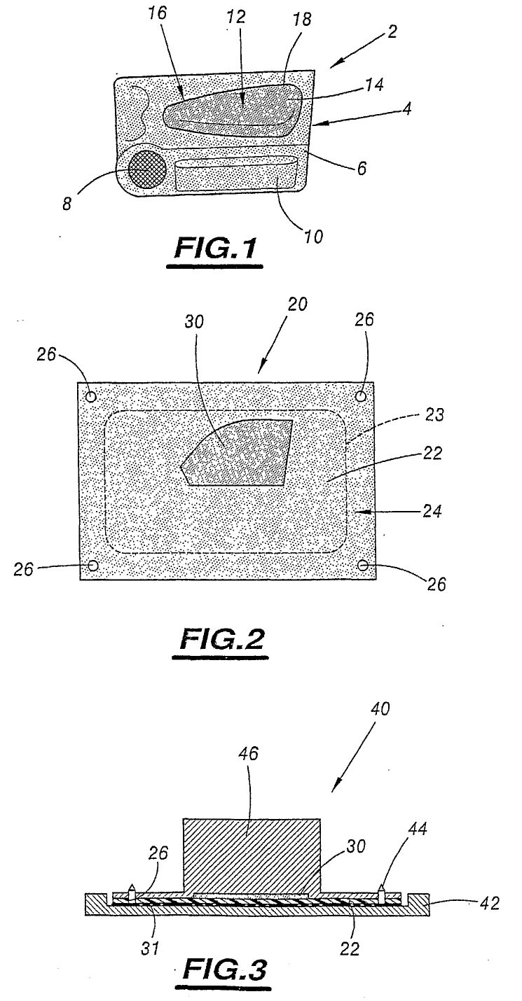

FIG. 1 is a diagrammatic side view of a first embodiment of a door inside panel in accordance with the invention;

FIG. 2 is a plan view of an assembly comprising two coating blanks in accordance with the invention;

FIG. 3 is a diagrammatic section view of a press for making the FIG. 2 assembly;

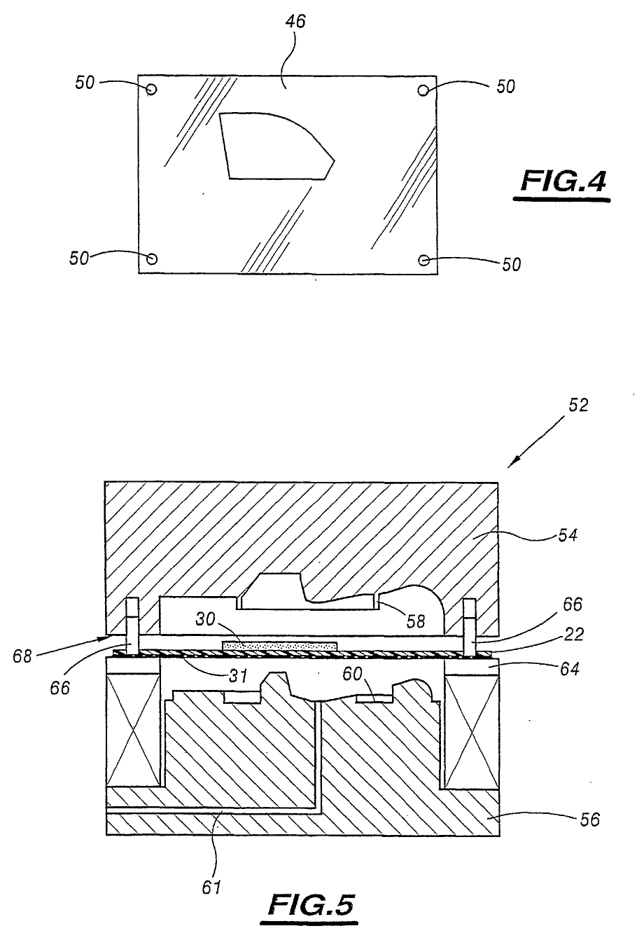

FIG. 4 is a view from beneath of the punch of the FIG. 3 press;

FIG. 5 is a diagrammatic section view of an injection mold for manufacturing the FIG. 1 panel, the mold being shown in the open state;

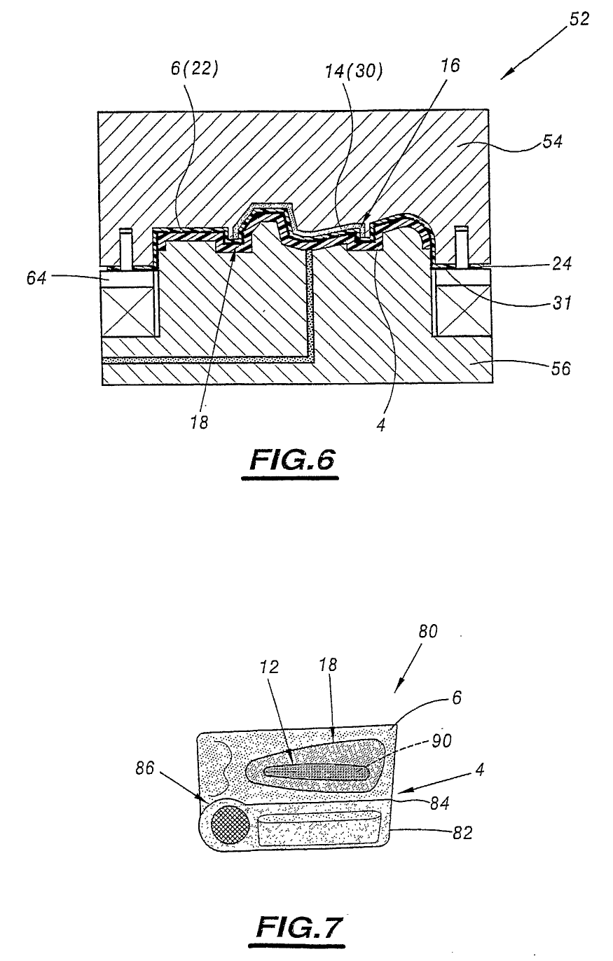

FIG. 6 shows the FIG. 5 mold in the closed state;

FIG. 7 is a diagrammatic side view of a second embodiment of a door inside panel in accordance with the invention;

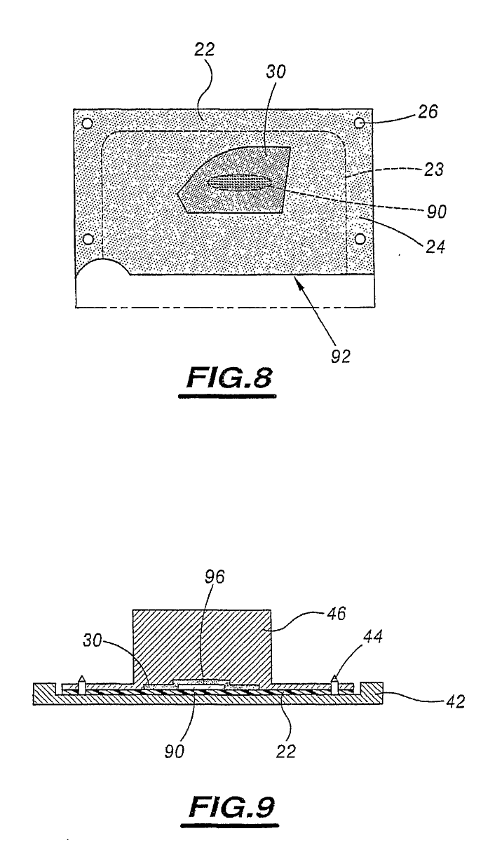

FIG. 8 is a plan view of an assembly of two coating blanks for the FIG. 7 panel;

FIG. 9 is a diagrammatic section view of a press for manufacturing the FIG. 8 assembly;

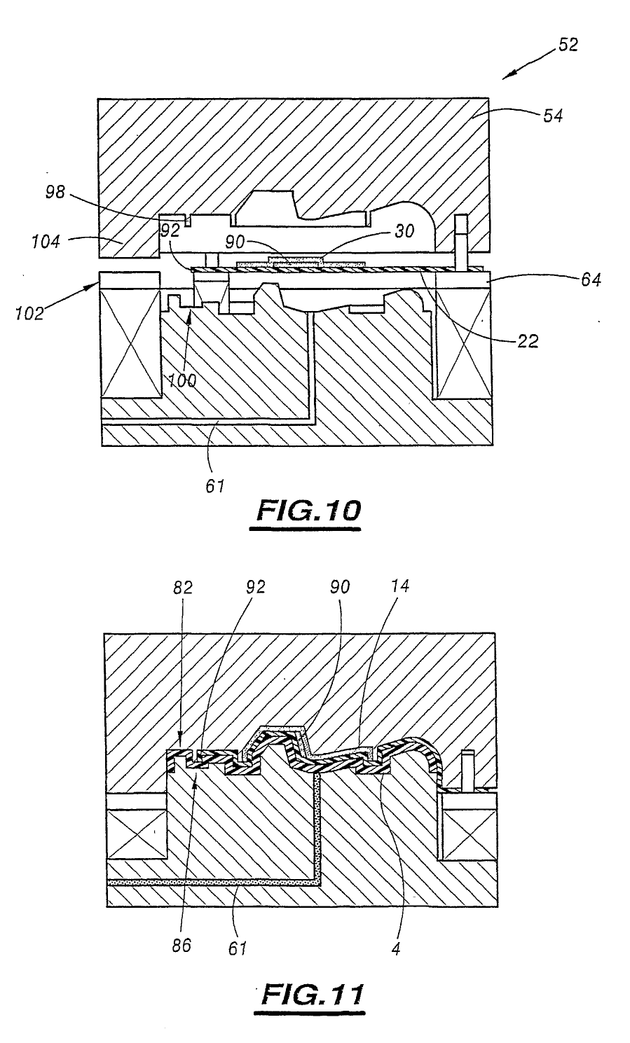

FIG. 10 is a diagrammatic section view of an injection mold for manufacturing the FIG. 7 panel, the mold being shown in the open state;

FIG. 11 shows the FIG. 10 mold in the closed state; and

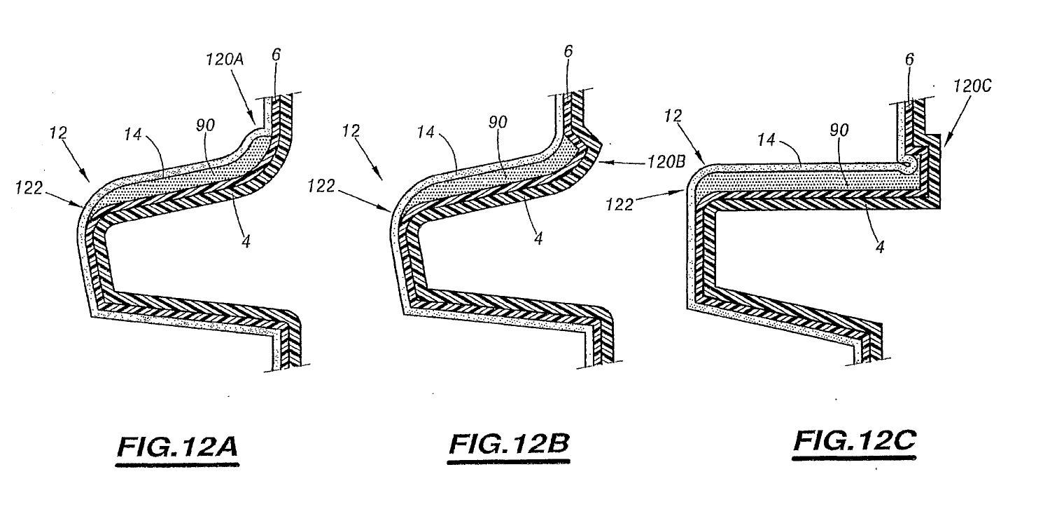

FIGS. 12A to 12C are two side views in section showing different ways in which armrests can be made.

FIG. 1 shows an inside panel for a motor vehicle door given overall reference 2.

The inside panel 2 is manufactured as a part 4 of injected plastics material.

This part is coated over its entire surface that is visible in the assembled state, i.e. its inside surface, in a main coating 6. This main coating 6 is constituted, for example, by a sheet of plastics material (e.g. PVC) or of low-cost leather.

The door panel 2 has recesses for components, e.g. a loudspeaker 8 and locations for parcel trays 10. It also has a projecting zone 12 forming an armrest.

The armrest zone 12 is coated in a secondary coating 14 of a selected material, e.g. a fabric. The secondary coating 14 is secured to the main coating 6.

Specifically, the secondary coating 14 is stuck directly to the main coating 6 by means of adhesive. The edge 16 of the secondary coating is hidden in a groove 18 formed in the injected part (see FIG. 6 below).

With reference to FIGS. 2 to 6, there follows a more detailed description of the method of manufacturing this panel.

In FIG. 2, there can be seen an assembly of two coating blanks for the door panel 2.

The assembly comprises a main coating blank 22 of rectangular shape. In a variant, this blank can be trapezoidal in shape. The blank 22 has a zone 23 corresponding to the coated surface of the door panel 2. It can be seen that the main blank 22 is of area greater than that of the coated surface 23 of the door panel 2 and that it includes a clamping margin 24 for holding the main blank 22 in a mold. The main blank 22 also has four positioning holes 26 through its clamping margin 24.

The blank assembly 20 also comprises a secondary blank 30. The shape of the secondary blank 30 corresponds to the shape of the armrest zone 12 of the door panel 2 after it has been shaped by closing the injection mold (see below).

The secondary blank 30 is stuck to the main blank 22. The adhesive used relies on adhesion at ambient temperature. It is applied to the two blank surfaces that are to be assembled together.

A sheet 31 for providing both blanks 22 and 30 with thermal protection can be stuck to the surface of the main blank 22 opposite from the secondary blank 30. This sheet 31 protects both of the blanks 22 and 30 from thermal degradation.

It should be observed that when the blanks 22 and 30 present different stretching properties as a function of direction, the blank concerned should be oriented in the manner appropriate to the shape that is to be made.

FIG. 3 shows a press for assembling the two blanks together.

The press 40 has a substantially flat matrix 42 with a recess corresponding to the main blank 22. It has four positioning studs 44 which co-operate with the positioning holes 26 of the main blank 22.

The press 40 also comprises a substantially flat punch 46 having a recess 48 corresponding to the shape of the secondary blank 30 (see FIG. 4). To position the punch 46 relative to the matrix 42, it also has positioning holes 50 which co-operate with the positioning studs 44 of the matrix-42 (FIG. 3).

With reference to FIGS. 5 and 6, there can be seen an injection mold 52 for manufacturing the FIG. 1 door panel 2. The injection mold 52 comprises a top half-mold 54 of generally concave shape and a bottom half-mold 56 of generally convex shape. The top half-mold 54 has a rib 58 surrounding the armrest portion of the mold. This rib 58 co-operates with a groove 60 formed in the bottom half-mold 56. The rib and the groove serve to form the groove 18 in the injected part 4 that hides the edge 16 of the secondary blank. An injection channel 61 is formed in the bottom half-mold 56 and opens out into the middle of its molding surface.

The mold 52 also has a clamping frame 64 which completely surrounds the convex bottom half-mold 56. The clamping frame 64 is movable vertically relative to the bottom half-mold 56 and is initially located above it.

The clamping frame 64 has positioning rods 66 which project upwards and which are disposed in the same manner as the studs 44 of the matrix 42 of the assembly press 40. The rods 66 co-operate with corresponding holes formed in the top half-mold 54. The assembly comprising the main blank 22 and the secondary blank 30 is positioned by the clamping frame 64 via the positioning holes 26 in the main blank 22 and it is clamped between the frame 64 and the bottom peripheral surface 68 of the top half-mold 54.

The main blank 22 then acts as the clamping margin for the secondary blank 30.

In FIG. 6, the mold 52 is shown in the closed state. Plastics material is injected into the mold adjacent to the main blank 22 and opposite from the secondary blank 30, via the injection channel 61.

The door panel is made as follows.

Firstly, the main blank 22 for the main coating is cut out to a rectangular shape. Thereafter the secondary blank 30 for the secondary coating is cut out in a shape that corresponds to the shape of the second zone of the door panel. The main blank 22 is then placed in the matrix of the press 40 and the secondary blank 30 is placed in the corresponding recess 30 of the punch 46.

Adhesive is applied to the two surfaces of the blanks 22 and 30 that are to be stuck together.

Thereafter the two blanks 22 and 30 are pressed against each other, the punch 46 is withdrawn, and the assembly comprising both blanks 22 and 30 is removed from the matrix.

The assembly comprising the two blanks 22 and 30 is placed on the clamping frame 64 of the open mold, with the secondary blank 30 being disposed on top. Exact positioning is obtained by the positioning rods 66 of the clamping frame and the corresponding positioning holes 26 of the main blank. The mold is closed. While the mold 52 is being closed, the two blanks 22 and 30 are stretched simultaneously in part by the three-dimensional shape of the mold, without any creases appearing. They then take on more or less the final shape of the coatings 6 and 14. During this step, the frame 64 is retracted downwards into the bottom half-mold 56.

Plastics material is injected into the mold against the bottom surface of the sheet 31, i.e. on the side of the main blank 22 that is opposite from the secondary blank 30. The injection pressure imparts the final shape to the coatings 6 and 14.

Thereafter, the plastics material is allowed to set, the mold 52 is opened, and a door panel blank is removed.

The inside panel 2 for a door is finished by cutting off the excess clamping margin 24 of the main coating 6.

It should be observed that the positioning rods (44, 64) in the various devices are in alignment in a frame of reference common to all of the steps of the method. This guarantees that all of the parts are in alignment relative to one another.

It should be observed that while injection is taking place, the main coating 6 protects the secondary coating from being degraded by the temperature and the pressure of the plastics material.

The fact that the plastics material does not pass through the main coating 6 ensures that the surface structure of the secondary coating 14 is conserved, e.g. a velvet structure, such that it is not necessary to use additional means for protecting the secondary coating.

FIGS. 7 to 12C show a second embodiment of the invention. In the description below, only the differences relative to the above-described first embodiment are described.

FIG. 7 shows a second embodiment of an inside panel 80 of the invention for a door.

As a difference relative to the panel of the first embodiment, only part of the apparent surface of the panel 80 in the assembled state is coated in the main coating 6.

This door panel 80 thus has an uncoated portion 82 of the injected plastics material 4 that remains visible.

The transition zone 84 between the coated and the uncoated portions is hidden by a groove 86 formed in the panel, analogous to the groove 18 used for hiding the edge of the secondary coating 14.

Furthermore, the panel 80 has a strip 90 of plastics foam in the convex zone 12 that forms the armrest. This strip 90 is sandwiched between the main coating 6 and the secondary coating 14. It is completely surrounded by a marginal region of the secondary coating 14. In the marginal region, the secondary coating 14 is secured directly to the main coating 6. In a variant, the strip can be surrounded over a large fraction of its periphery by the marginal region 14.

FIG. 8 shows an assembly comprising two blanks with the foam strip 90 incorporated therein.

It can be seen that the main blank 22 is substantially rectangular in shape, the three sides of the clamping margin 24 which correspond to the coated sides of the panel 80 and extending as far as the edge of this panel are identical to those of the assembly 20 shown in FIG. 2.

The free side 92 corresponding to the transition zone 84 is cut to shape to match the outline of this zone 84.

FIG. 9 shows that an additional recess 96 is provided in the punch 46, which recess 96 corresponds to the shape of the foam strip 90.

The mold 52 shown in FIGS. 10 and 11 has an additional rib 98 and an additional groove 100 for forming the transition zone 84 in the panel.

The clamping frame 64 of the mold 52 is modified so as to take account of the offset position of the positioning holes 26. The clamping frame 64 of the mold holds the main blank 22 along three sides only of the clamping margin 24, and the free side is not held. The side 102 of the clamping frame 64 and the side 104 of the top half-mold 54 which corresponds to the free side of the panel are complementary in profile so as to close the mold so as to prevent liquid plastics material leaking out during injection.

FIGS. 12A to 12C show various shapes of armrest 12 that can be made using the method of the invention.

In FIG. 12A, the shape of the top edge of the plastics foam strip 90 can be seen and constitutes a bead 120A, while the wall of the plastics material part 4 of the door panel 80 presents continuous curvature in this zone.

In FIG. 12B, the top edge of the strip 90 of plastics foam is hidden by the fact that it is received in a recess 120B formed in the wall of the door panel 80. Consequently, tension exerted by the strip 90 on the secondary coating 14 is reduced compared with the embodiment shown in FIG. 12A.

The top edge of the foam strip 90 can be completely hidden in a hollow 120C of the panel, as shown in FIG. 12C.

At its opposite edge, the foam strip 90 is terminated in all three embodiments where the convex edge 122 of the armrest is located (on the left in FIGS. 12A to 12C). The foam swells progressively after unmolding due to the tension of the fabric constituting the secondary coating 14.

It can be seen that the method of the invention makes it possible to manufacture a door panel having zones that are coated with different coatings without it being necessary to provide clamping margins for the secondary coatings or for the strip of plastics foam.

This saves on raw materials. In addition, given that the door panel is made by overmolding all of the coatings in a single step, manufacture takes place more quickly.

Furthermore, the capital investment required in machines for shaping the secondary coating can be saved.

In a variant, the strip of plastics foam can be secured to the main blank and/or the secondary blank by means other than adhesive, e.g. by heat-sealing.

In general, the coatings, the strip of plastics foam, and the thermal protection sheet can be secured to one another by any suitable means.

It should be observed that various overmolding techniques can be used for manufacturing the door panel of the invention, e.g. overmolding by injection and compression, by extrusion and compression, or by thermocompression.

1/ A method of manufacturing a coated part (2), in particular for a motor vehicle, the part being of the type comprising a structure (4) for injected plastics material coated in at least a first zone of its surface by a main coating (6) and in at least a second zone of its surface by a secondary coating (14), said second surface zone being surrounded on at least a fraction of its periphery by said first zone, the method being characterized in that it comprises the following steps:
cutting out a main blank (22) for the main coating (6) to a size greater than the area of said first zone, thereby providing a clamping margin (24);
cutting out a secondary blank (30) for the secondary coating (14) to a size and a shape corresponding substantially to said second zone;
securing the secondary blank (30) to the main blank (22) on an area of said main blank (22) that is to remain visible, in a location that corresponds to said second zone;
placing the assembly comprising the main blank (22) and the secondary blank (30) on a clamping frame (64) in a mold (52), which frame positions the clamping margin (24) of the main blank (22);
closing the mold (52), with the assembly comprising the main blank (22) and the secondary blank (30) being shaped during closure to take up the shape of the mold (52), at least in part;
overmolding the plastics material (4) onto the assembly comprising the main blank (22) and the secondary blank (30) on the side of the main blank (22) opposite from the secondary blank (30);
allowing the plastics material (4) to set, and unmolding the structure as a whole; and
cutting off the clamping margin (24) of the main blank (22).

2/ A method according to claim 1, characterized in that the secondary blank (30) is secured to the main blank by adhesive.

3/ A method according to claim 1 or claim 2, characterized in that the main blank (22) and the secondary blank (30) are stretched, at least in part, simultaneously during closure of the mold (52).

4/ A method according to any one of claims 1 to 3, characterized in that it further comprises the following steps:
positioning a strip (90) of plastics foam on the main blank (22) in a zone lying within said second zone; and
securing the secondary blank (30) to the visible surface of the main blank (22) so as to cover the foam strip (90) at least in part, and preferably completely.

5/ A method according to claim 4, characterized in that the foam strip (90) is secured to the main blank (22).

6/ A method according to claim 5, characterized in that the foam strip (90) is secured to the main blank by adhesive.

7/ A method according to any one of claims 4 to 6, characterized in that the foam strip (90) is sandwiched between the main blank (22) and the secondary blank (30), and in that the strip (90) is surrounded at least in part and preferably completely by a marginal region of the secondary blank (22).

8/ A method according to any preceding claim, characterized in that the main blank (22) is held around its entire periphery in the clamping frame (64).

9/ A method according to any one of claims 1 to 7, for manufacturing a part that is partially coated in the main coating on one side, the method being characterized in that the main blank (22) is cut out to a shape whose outline on one side (92) corresponds to the boundary (84) between the main coating (6) and the non-coated portion (82), and in that the clamping margin (24) is provided on the other sides of the blank.

10/ A method according to claim 8 or claim 9, characterized in that the main blank (22) is substantially rectangular in shape.

11/ A method according to any preceding claim, characterized in that it further comprises the following steps:
fixing the main blank (22) in a matrix (42) in a defined position;
fixing the secondary blank (30) in a recess in a punch (46) for co-operating with a matrix (42), the recess being complementary in shape to the secondary blank (30) and being situated at a location that corresponds to the location of the secondary blank (30) on the main blank (22);
applying the punch (46) against the matrix (42); and
withdrawing the punch (46) and withdrawing the assembly comprising the main blank (22) and the secondary blank (30) from the matrix (42).

12/ A method according to any preceding claim, characterized in that a common reference system is used for all of the operations of positioning the parts relative to one another.

13/ A method according to any preceding claim, characterized in that a thermal protection sheet (31) for the main blank (22) and for the secondary blank (30) is secured, in particular by adhesive, on the surface of the main blank (22) opposite from the secondary blank (30).

14/ A part manufactured by a method according to any one of claims 1 to 13, characterized in that the part includes a groove (18) formed in the coated surface, and in that the outline of the groove (18) corresponds substantially to the outline of said secondary coating (14) and receives the edge (16) of said secondary coating, so as to hide it.

15/ A coated part according to claim 14, manufactured by a method according to claim 9 or any claim dependent thereon, the part being characterized in that it includes a groove (86) formed in the coated surface and receiving the free edge (92) of the main coating (22) so as to hide it.

16/ A coated part according to claim 14 or claim 15 manufactured using a method according to claim 13, characterized in that it includes a thermal protection sheet (31) for protecting the main blank (22) and the secondary blank (30), which sheet is fixed to the surface of the main blank (22) opposite from the secondary blank (30).

17/ A coated part according to any one of claims 14 to 16, manufactured by a method according to claim 4 or any claim which depends thereon, the part being characterized in that it includes a strip (90) of plastics foam clamped between the main coating (6) and the secondary coating (14).

18/ A coated part according to any one of claims 14 to 17, characterized in that it forms an inside panel (2) for a motor vehicle door.

19/ A coated part according to claims 16 and 17 in combination, characterized in that it includes an armrest-forming zone (12), and in that the strip (90) of plastics foam lies in the armrest-forming zone (12).
